(19) United States
(12) Patent Application Publication
(10) Pub. No.: US 2002/0167530 A1
(43) Pub. Date: Nov. 14, 2002

(54) Anti-alias font generator

(76) Inventors: Yukari Hiratsuka, Tokyo (JP); Hitoshi Fujimoto, Tokyo (JP); Masatoshi Kameyama, Tokyo (JP)

Correspondence Address: BIRCH STEWART KOLASCH & BIRCH, PO BOX 747, FALLS CHURCH, VA, 22040-0747, US

(21) Appl. No.: 09/986,373

(22) Filed: Nov. 8, 2001

(30) Foreign Application Priority Data
May 14, 2001 (JP) 2001-143098

(51) Int. Cl. G09G 5/00

(52) U.S. Cl. 345/611

(57) ABSTRACT

An anti-alias font generator includes a stipple buffer that holds the gradation data of an anti-alias font, a source color register that sets a font display color, and a blender that blends the value of the source color register and the destination color value on the frame memory in accordance with the blend coefficient with the gradation data as the blend coefficient.

This application is based on Application No. 2001-143098, filed in Japan on May 14, 2001, the contents of which are hereby incorporated by reference.

### BACKGROUND OF THE INVENTION

1. Field of the Invention

The present invention relates to an anti-alias font display, and more particularly to an anti-alias font generator that generates an anti-alias font at a high speed.

2. Description of the Related Art

Up to now, in an information display device for a computer or the like, there has been employed a method in which when a bit map font of one bit per one pixel is drawn, font data is held in a stipple buffer, and stipple data of one bit is color-extended and developed to display.

Also, at present, in an information display device for a computer or the like, in order to improve the readability of the character in a low pixel font, there has been employed a multi-value gradation font that expresses a character by a plurality of gradation (color density).

A conventional display method using a multi-value gradation font will be described with reference to the drawing. FIG. 7 is a diagram showing the structure of a conventional multi-value gradation font display unit.

In FIG. 7, reference numeral 1 denotes a CPU; and 2, a frame memory.

Then, the operation of the conventional multi-value gradation font display unit will be described with reference to the drawing.

FIG. 8 is a diagram showing an anti-alias font display example of the conventional multi-value gradation font display unit.

The CPU 1 draws a pixel color value based on a multi-value in the frame memory 2 is displayed on a screen.

FIG. 8 shows a case in which the multi-value gradation font of a character A is displayed on the screen. In the example shown in the figure, the character A is made up of 8×8 pixels, the multi-value gradation font of four gradations, and font data of pixel color values (R1, G1, B1) with the darkest density, pixel color values (R2, G2, B2) with a darker density, pixel color values (R3, G3, B3) with a lighter density and background colors (R0, G0, B0).

The CPU 1 draws those pixel color values at display positions of the screen (frame memory 2) pixel by pixel for 8×8 pixels.

In the above-described conventional multi-value gradation font display, since the pixel color values are drawn pixel by pixel by the CPU 1, there arises a problem in that a load on the CPU 1 is high and a long drawing period of time is required.

The multi-value gradation font is made for the purpose of preventing the anti-aliasing of a character, and in the present invention, the “multi-value gradation font” used for this purpose is called “anti-alias font”.

### SUMMARY OF THE INVENTION

The present invention has been made to solve the above-described problem, and therefore an object of the present invention is to provide an anti-alias font generator which is capable of generating an anti-alias font at a high speed.

In order to achieve the above object, according to a first aspect of the present invention, there is provided an anti-alias font generator comprising a stipple buffer for holding the gradation data of an anti-alias font; a source color register for setting a font display color; and a blender for blending a value of the source color register and a destination color value on the frame memory in accordance with a blend coefficient which is the gradation data.

According to a second aspect of the present invention, in the anti-alias font generator, the blender blends the source color register value and the destination color value in accordance with α×Cs+(1−α)×Cd assuming that the anti-alias font bit map gradation data value held in the stipple buffer is α, and the value of the source color register is Cs and the destination color value on the frame memory is Cd.

According to a third aspect of the present invention, there is provided an anti-alias font generator comprising: a stipple buffer for holding the gradation data of an anti-alias font; a foreground color register for setting a font display color; a background color register for setting a background color; and a blender for blending a font display color of the foreground color register and the background color of the background color register in accordance with the blend coefficient which is the gradation data.

According to a fourth aspect of the present invention, in the anti-alias font generator, the blender blends the source color register value and the destination color value in accordance with α×Cf+(1−α)×Cb assuming that the anti-alias font bit map gradation data value held in the stipple buffer is α, the value of the foreground color register is Cf and the value of the background register is Cb.

According to a fifth aspect of the present invention, there is provided an anti-alias font generator, comprising: a stipple buffer for holding the gradation data of an anti-alias font; a plurality of display color registers for setting a display color on the basis of the gradation value of the anti-alias font; and a stipple color selector for selecting the value of the plurality of display color registers in accordance with the gradation data.

According to a sixth aspect of the present invention, in the anti-alias font generator, the plurality of display color registers are structured by a first foreground color register, a second foreground color register, a third foreground color register and a background color register, and the stipple color selector selects a display color from the first foreground color register if the anti-alias font bit map gradation data is first gradation data, a display color from the second foreground color register if the anti-alias font bit map gradation data is second gradation data, a display color from the third foreground color register if the anti-alias font bit map gradation data is third gradation data, and a display color from the background color register if the anti-alias font bit map gradation data is fourth gradation data, in accordance with the anti-alias font bit map gradation data in the stipple buffer.

### BRIEF DESCRIPTION OF THE DRAWINGS

These and other objects and advantages of this invention will become more fully apparent from the following detailed description taken with the accompanying drawings in which:

FIG. 1 is a block diagram showing the structure of an anti-alias font generator in accordance with a first embodiment of the present invention;

FIG. 2 is a diagram showing the operation of the anti-alias font generator in accordance with the first embodiment of the present invention;

FIG. 3 is a block diagram showing the structure of an anti-alias font generator in accordance with a second embodiment of the present invention;

FIG. 4 is a diagram showing the operation of the anti-alias font generator in accordance with the second embodiment of the present invention; anti-alias font generator in accordance with a third embodiment of the present invention;

FIG. 6 is a diagram showing the operation of the anti-alias font generator in accordance with the third embodiment of the present invent ion ;

FIG. 7 is a block diagram showing the structure of a conventional anti-alias font generator; and

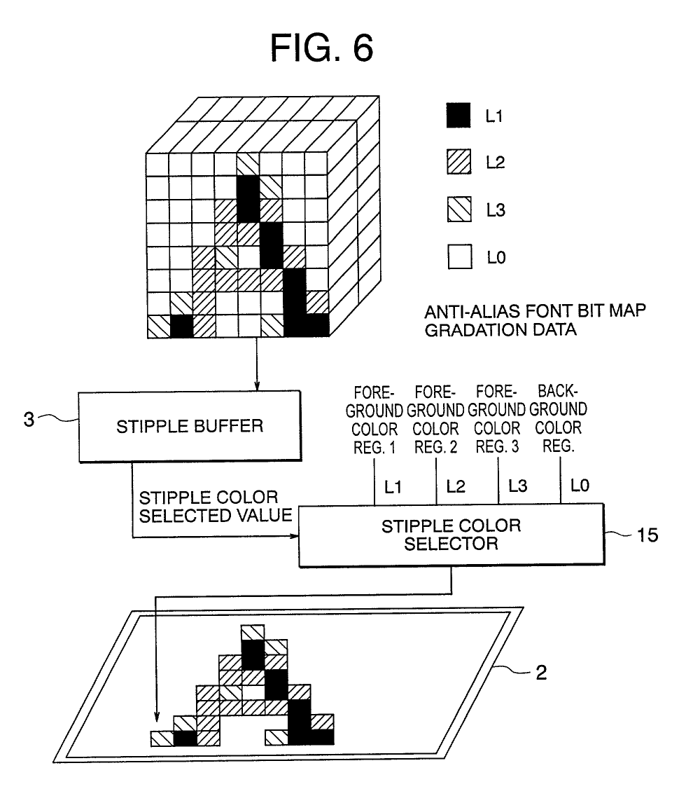

FIG. 8 is a diagram showing the operation of the conventional anti-alias font generator.

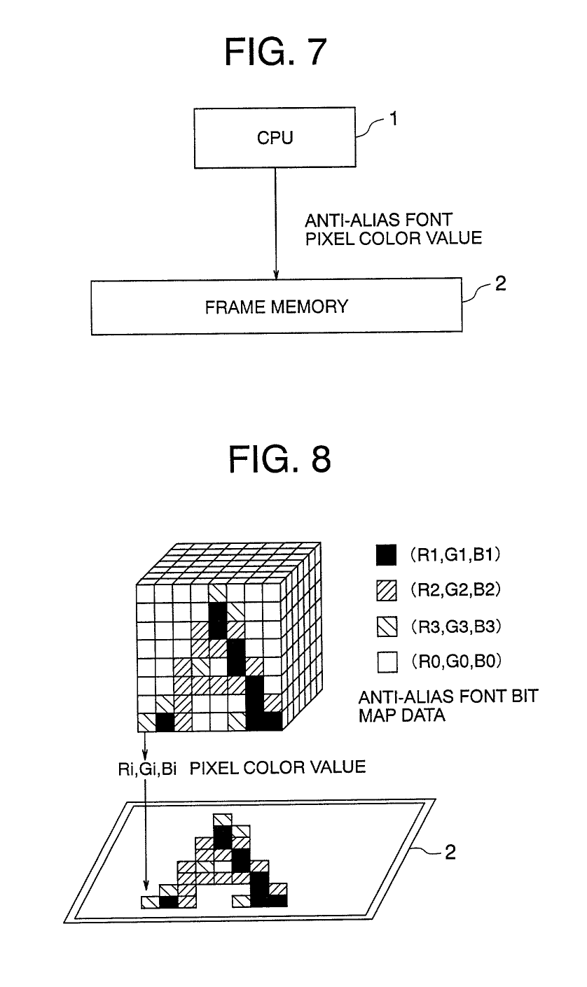

### DETAILED DESCRIPTION OF THE PREFERRED EMBODIMENTS

Now, a description will be given in more detail of preferred embodiments of the present invention with reference to the accompanying drawings.

(First Embodiment)

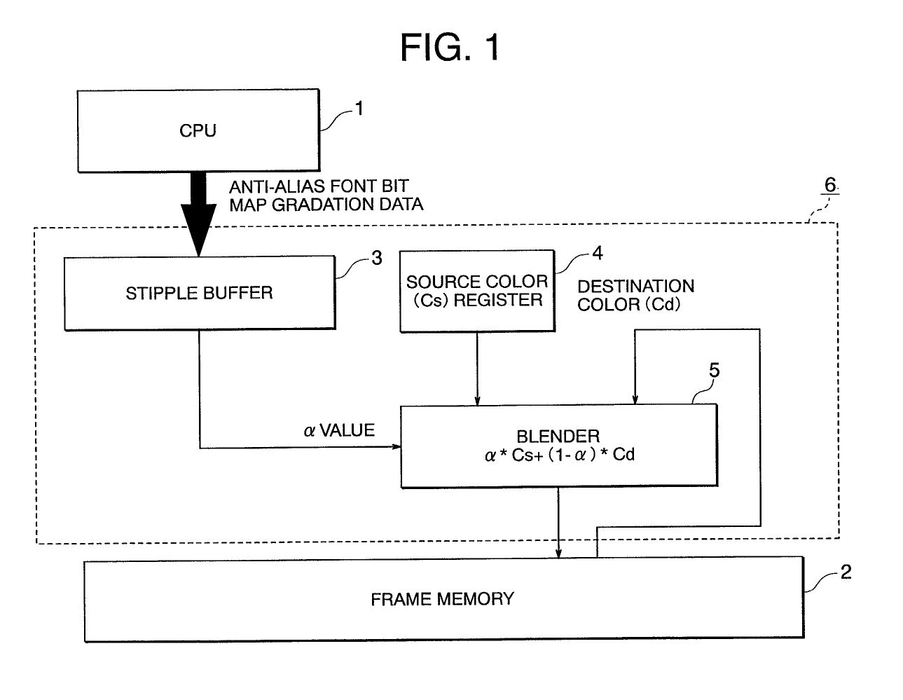

An anti-alias font generator in accordance with a first embodiment of the present invention will be described with reference to the accompanying drawings. FIG. 1 is a diagram showing the structure of an anti-alias font generator in accordance with a first embodiment of the present invention. In the respective figures, the same references denote the identical or corresponding parts.

In FIG. 1, reference numeral 1 denotes a CPU that has an anti-alias font and controls a drawing process; 2, a display frame memory that draws the anti-alias font; 3, a stipple buffer that holds the gradation data of the anti-alias font from the CPU 1 and has a plurality of bits per one pixel; 4, a source color register that sets a font display color; 5, a blender such as a calculator which blends the destination color value on the frame memory (display screen) 2 and the font display colors of the source color register 4 with the anti-alias font bit map gradation data held in the stipple buffer 3 as an α value; and 6, a high-speed anti-alias font generator in accordance with the first embodiment. The anti-alias font generator 6 is realized by a hardware accelerator or the like.

Then, the operation of the anti-alias font generator in accordance with the first embodiment will be described with reference to the figures.

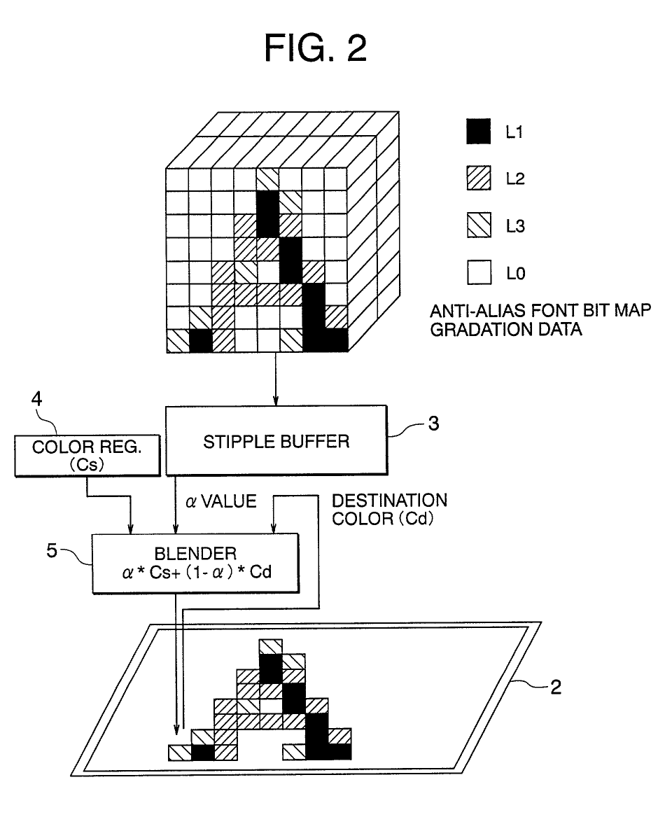

FIG. 2 is a diagram showing an appearance in which the anti-alias font of a character “A” is displayed on a screen by the anti-alias font generator in accordance with the first embodiment of the present invention.

First, the gradation data of the anti-alias font is transferred to and held in the stipple buffer 3 within the high-speed anti-alias font generator 6 in a lump by the CPU 1.

Then, the high-speed anti-alias font generator 6 blends the font display color in the source color register 4 and the destination color value read from the frame memory (display screen) 2 with the anti-alias font bit man gradation data in the stipple buffer 3 as the α value by the blender 5, and draws the blended result on the frame memory 2, to thereby generate the anti-alias font.

In an example shown in FIG. 2, the character A is an anti-alias font having 8×8 pixels and four-level gradations and made up of levels L1, L2, L3 stated in the order from the darkest gradation and a level L0 that penetrates the background. That is, the anti-alias font bit map gradation data of 8×8 pixels represented by 2 bits is held in the stipple buffer 3 in a lump, and the value Cs of the source color register 4 and the destination color value Cd on the screen are blended with the gradation data L0 to L3 on the stipple buffer 3 as the α value in accordance with the following expression (1) and drawn on the screen.

α×Cs+(1−α)×Cd (1)

In this situation, the gradation data held as the α value is set in such a manner that 11b is α=1.0, 10b is α=0.67, 10b is α=0.33, and 00b is α=0 assuming that L1=11b, L2=10b, L3=10b, and L0=00b.

As described above, with the use of the anti-alias font generator 6 in accordance with the first embodiment, since the value of the source color register 4 and the data on the screen are blended and drawn with the gradation data as the α value within the anti-alias font generator 6, the CPU 1 merely transfers the gradation data of the anti-alias font in one lump without conducting further operation, and a load on the CPU 1 is lessened, thereby being capable of generating the anti-alias font at a high speed.

(Second Embodiment)

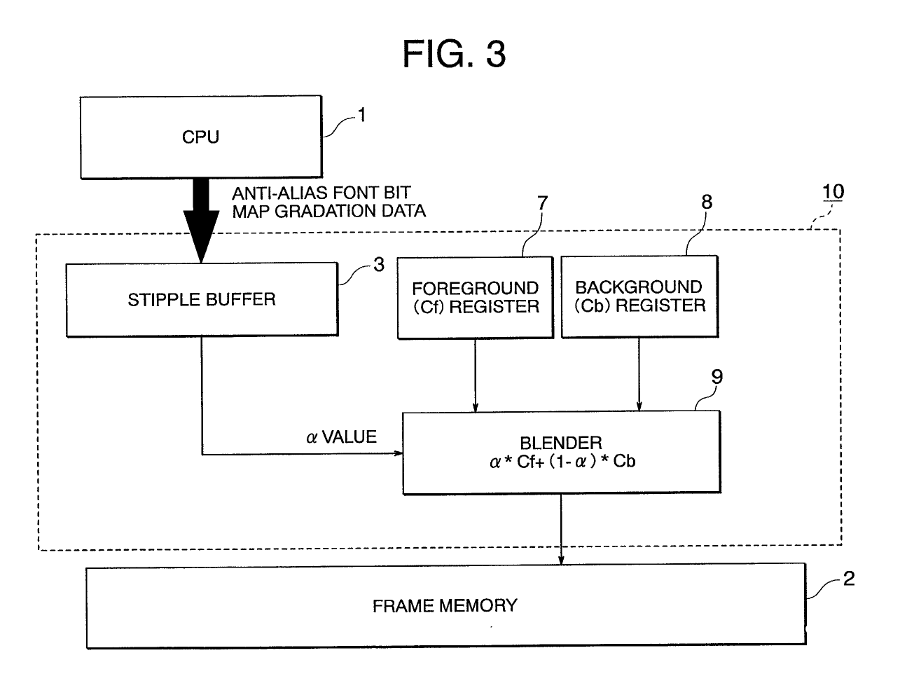

An anti-alias font generator in accordance with a second embodiment of the present invention will be described with reference to the figures. FIG. 3 is a diagram showing the structure of an anti-alias font generator in accordance with a second embodiment of the present invention.

In FIG. 3, a reference numeral 1 denotes a CPU that has an anti-alias font and controls a drawing process; 2, a display frame memory that draws the anti-alias font; 3, a stipple buffer that holds the gradation data of the anti-alias font from the CPU 1 and has a plurality of bits per one pixel; 7, a foreground register that sets a font display color; 8, a background register that sets a background color; 9, a blender such as a calculator which blends the font display color of the foreground register 7 and the background color of the background register 8 with the anti-alias font bit map gradation data held in the stipple buffer 3 as an a value; and 10, a high-speed anti-alias font generator in accordance with the second embodiment. The anti-alias font generator 10 is realized by a hardware accelerator or the like.

In the above-described first embodiment, the value of the source color register 4 and the data on the screen are blended to be drawn with the gradation data as the α value. However, in this second embodiment, there is shown a case in which over-drawing is made on the screen.

Then, the operation of the anti-alias font generator in accordance with the second embodiment will be described with reference to the figures.

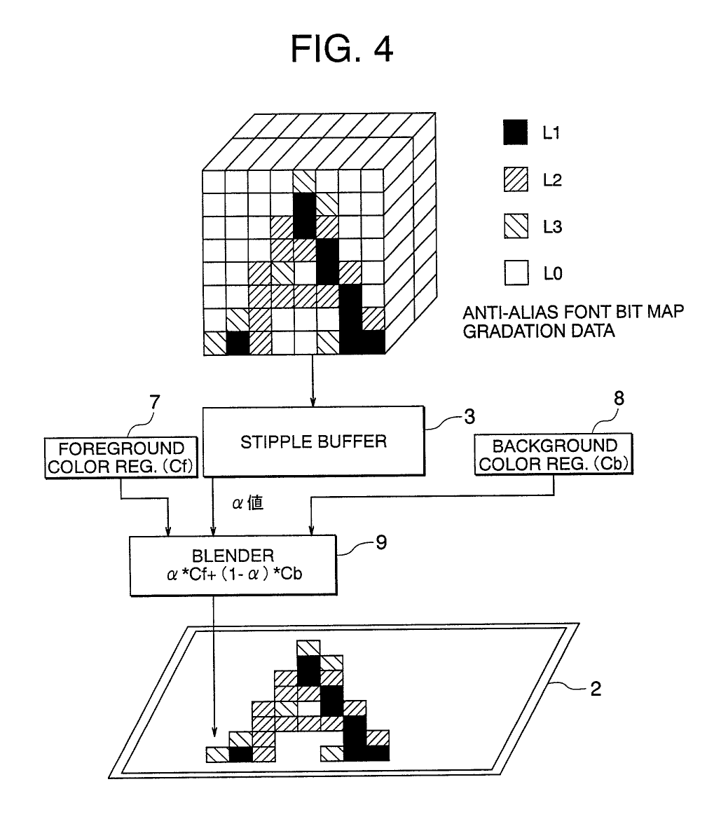

FIG. 4 is a diagram showing an appearance in which the anti-alias font of a character “A” is displayed on a screen by the anti-alias font generator in accordance with the second embodiment of the present invention.

First, the gradation data of the anti-alias font is transferred to and held in the stipple buffer 3 within the high-speed anti-alias font generator 10 in a lump by the CPU 1.

Then, the high-speed anti-alias font generator 10 blends the font display color in the foreground color register 7 and the background color in the background color register 8 with the anti-alias font bit map gradation data in the stipple buffer 3 as the α value by the blender 9, and draws the blended result on the frame memory 2, to thereby generate the anti-alias font.

In an example shown in FIG. 4, the character A is an anti-alias font having 8×8 pixels and four-level gradations and made up of levels L1, L2, L3 stated in the order from the darkest gradation and a level L0 that penetrates the background. That is, the anti-alias font bit map gradation data of 8×8 pixels represented by 2 bits is held in the stipple buffer 3 in a lump, and the value Cf of the foreground color register 7 and the value Cb of the background color register 8 are blended with the gradation dataL0 to L3 on the stipple buffer 3 as the α value in accordance with the following expression (2) and drawn on the screen.

α×Cf+(1−α)×Cb (2)

In this situation, the gradation data held as the α value is set to, for example, L1=11, L2=10, L3=01, and L0=00.

As described above, with the use of the anti-alias font generator 10 in accordance with the second embodiment, since the value of the foreground color register 7 and the value of the background color register 8 are blended and drawn with the gradation data as the α value within the anti-alias font generator 10, the CPU 1 merely transfers the gradation data of the anti-alias font in one lump without conducting further operation, and a load on the CPU 1 is lessened, thereby being capable of over-writing the anti-alias font at a high speed.

(Third Embodiment)

An anti-alias font generator in accordance with a third embodiment of the present invention will be described with reference to the figures. FIG. 5 is a diagram showing the structure of an anti-alias font generator in accordance with a third embodiment of the present invention.

In FIG. 5, a reference numeral 1 denotes a CPU that has an anti-alias font and controls a drawing process; 2, a display frame memory that draws the anti-alias font; 3 a stipple buffer that holds the gradation data of the anti-alias font from the CPU 1 and has a plurality of bits per pixel; 11, a foreground color 1 register that sets a display foreground color 1 corresponding to the gradation data 1; 12, a foreground color 2 register that sets a display foreground color 2 corresponding to the gradation data 2; 13, a foreground color 3 register that sets a display foreground color 3 corresponding to the gradation data 3; 14, a background color register that sets a display background color corresponding to the gradation data 0; 15, a stipple color selector that selects the values of the above display color registers 11 to 14 in accordance with the anti-alias font bit map gradation data held in the stipple buffer 3; and 16, a high-speed anti-alias font generator in accordance with the third embodiment. The anti-alias font generator 16 is realized by a hardware accelerator or the like.

In the above-described second embodiment, the value of the foreground color register 7 and the value of the background color register 8 are blended to be drawn with the gradation data as the α value. However, in this third embodiment, there is shown a case in which over-drawing is made on the screen by a simple circuit.

Then, the operation of the anti-alias font generator in accordance with the third embodiment will be described with reference to the figures.

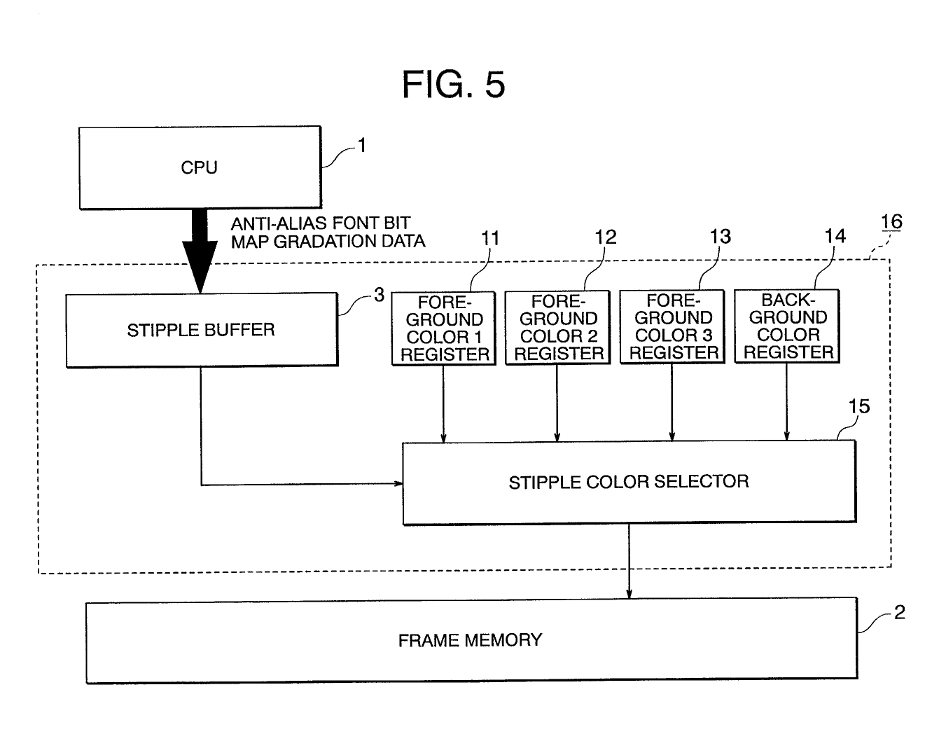

FIG. 6 is a diagram showing an appearance in which the anti-alias font of a character “A” is displayed on a screen by the anti-alias font generator in accordance with the third embodiment of the present invention.

First, the gradation data of the anti-alias font is transferred to and held in the stipple buffer 3 within the high-speed anti-alias font generator 16 in a lump by the CPU 1.

Then, the high-speed anti-alias font generator 16 selects the display color in the foreground color 1 register 11 if the anti-alias font bit map gradation data is the gradation data 1, the display color in the foreground color 2 register 12 if the anti-alias font bit map gradation data is the gradation data 2, the display color in the foreground color 3 register 13 if the anti-alias font bit map gradation data is the gradation data 3, the display color in the background color register 14 if the anti-alias font bit map gradation data is the gradation data 0, in accordance with the anti-alias font bit map gradation data in the stipple buffer 3 by the stipple color selector 15 to draw the data on the frame memory 2, thereby generating the anti-alias font.

In an example shown in FIG. 6, the character A is an anti-alias font having 8×8 pixels and four-level gradations and made up of levels L1, L2, L3 stated in the order from the darkest gradation and a level L0 that penetrates the background. That is, the anti-alias font bit map gradation data of 8×8 pixels represented by 2 bits is held in the stipple buffer 3 in a lump, and the foreground color 1 in case of L1, the foreground color 2 in case of L2, the foreground color 3 in case of L3 and the background color in case of L0 are selected and drawn on the screen with the gradation data L0 to L3 on the stipple buffer 3 as the stipple color selected value. In this situation, the color values are set in the order from the darkest density in the foreground color 1 register 11 to the foreground color 3 register 13, and the background color is set in the background color register 14.

As described above, with the use of the anti-alias font generator 16 in accordance with the third embodiment, since the display color based on the gradation in the register is selected and drawn with the gradation data as a selected value within the anti-alias font generator 16, the CPU 1 merely transfers the gradation data of the anti-alias font in one lump by a very simple circuit, and the load on the CPU 1 is lessened, thereby being capable of over-writing the anti-alias font at a high speed.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An anti-alias font generator comprising:
a stipple buffer for holding gradation data of an anti-alias font;
a source color register for setting a font display color; and
a blender for blending a value of said source color register and a destination color value on a frame memory in accordance with a blend coefficient which is the gradation data.

2. An anti-alias font generator as claimed in claim 1, wherein said blender blends the source color register value and the destination color value in accordance with α×Cs+(1−α)×Cd assuming that the anti-alias font bit map gradation data value held in the stipple buffer is α, and the value of said source color register is Cs and the destination color value on said frame memory is Cd.

3. An anti-alias font generator comprising:
a stipple buffer for holding gradation data of an anti-alias font;
a foreground color register for setting a font display color;
a background color register for setting a background color; and
a blender for blending a font display color of said foreground color register and the background color of said background color register in accordance with the blend coefficient which is the gradation data.

4. An anti-alias font generator as claimed in claim 3, wherein said blender blends the source color register value and the destination color value in accordance with α×Cf+(1−α)×Cb assuming that the anti-alias font bit map gradation data value held in said stipple buffer is α, the value of said foreground color register is Cf and the value of the background register is Cb.

5. An anti-alias font generator, comprising:
a stipple buffer for holding gradation data of an anti-alias font;
a plurality of display color registers for setting a display color on the basis of the gradation value of said anti-alias font; and
a stipple color selector for selecting the value of said plurality of display color registers in accordance with said gradation data.

6. An anti-alias font generator as claimed in claim 5, wherein said plurality of display color registers are structured by a first foreground color register, a second foreground color register, a third foreground color register and a background color register, and said stipple color selector selects a display color from said first foreground color register if the anti-alias font bit map gradation data is first gradation data, a display color from said second foreground color register if the anti-alias font bit map gradation data is second gradation data, a display color from said third foreground color register if the anti-alias font bit map gradation data is third gradation data, and a display color from said background color register if the anti-alias font bit map gradation data is fourth gradation data, in accordance with the anti-alias font bit map gradation data in said stipple buffer.
